(19) United States
(12) Patent Application Publication
(10) Pub. No.: US 2003/0081799 A1
(43) Pub. Date: May 1, 2003

(54) Flat panel sound radiator with enhanced audio performance

(76) Inventors: Michael Klasco, Berkley, CA (US); Pablo Tobiano, San Marino, CA (US); Carlos Go, San Francisco, CA (US)

Correspondence Address: Womble Carlyle Sandridge & Rice, PLLC, P.O Box 7037, Atlanta, GA, 30357-0037, US

(21) Appl. No.: 10/003,928

(22) Filed: Oct. 31, 2001

(51) Int. Cl. H04R 25/00; H04R 1/00; H04R 9/06; H04R 11/02

(52) U.S. Cl. 381/152; 381/425; 381/426

(57) ABSTRACT

A flat panel sound radiator having improved audio performance is provided. The sound radiator has a panel to which is coupled a traditional electromechanical exciter for imparting audio frequency vibrational energy to the panel. The panel has a honeycomb core made of Kraft paper, which is flexible, has a low self noise, and high noise damping characteristics. The core is sandwiched between facing skins made of a material with a high Young's modulus, a high tan delta, a high tensile strength, and low self noise. Preferably, this material is an aramid polyamide such as Kevlar®, Nomex®, Conex®, or Technora®, all of which exhibit these properties. The facing skins are fixed to the core with an adhesive that is flexible and has high acoustic damping qualities and high shock resistance, such as rubber cements, silicone adhesives, and water-based acrylic adhesives. The result of the combination of these materials with their respective properties is a flat panel sound radiator that exhibits signal-to-noise greater than 40 dB for an 85 dB input signal within key audio frequency ranges, which is 20 dB or more greater than prior art flat panel sound radiators. Base response and sound level capacity are also dramatically enhanced.

### TECHNICAL FIELD

This invention relates generally to audio transducers and more particularly to flat panel sound radiators wherein a flat panel rather than a traditional cone is vibrated by an exciter (also referred to as a transducer or motor) to reproduce an audio program.

### BACKGROUND

In a traditional cone-type speaker, a cone made of paper, plastic, aluminum, or another appropriate material is mounted and supported in a rigid frame by a flexible surround that extends about the periphery of the cone and a circumferentially corrugated spider that extends about the cone near its apex. The cone, or diaphragm, is the acoustic radiating surface, which couples to the surrounding air mechanical forces generated by the interaction of currents flowing through a voice coil disposed in a strong magnetic field within a “voice coil gap.”

The voice coil is a helically wound assembly of wire on a hollow cylindrical bobbin. It is attached to the cone at its apex and extends into the annular gap of a magnet motor assembly mounted to the back of a speaker frame. Thus, the diaphragm plus voice coil assembly may move freely in the axial direction, but is constrained otherwise.

The voice coil is coupled to an audio amplifier, which feeds the voice coil with alternating electrical current with the level and temporal characteristics analogous to the sound that will be reproduced. These currents, in turn, generate a force acting on (accelerating) the mass of the voice coil, according to the equation F=Bli, where F is the force, B is the magnetic flux around the coil, L is the length of the voice coil wire, and I, the current. The force generates axial acceleration of the voice coil within the magnetic field. The voice coil bobbin couples these forces to the cone apex, which causes the cone to vibrate, thereby reproducing the original audio program and projecting it into the listening area.

In the case of a low frequency speaker or woofer, the cone moves as a piston for sound energy with wavelengths greater than the diameter of the cone. This typically corresponds to audio frequencies less than about 1 to 2 KHz. For audio frequencies higher than this (i.e. beyond the pistonic operational range of the speaker), the sound reproduction of the woofer becomes rough and noisy. This is because such frequencies are reproduced in the woofer not by pistonic movement but rather by a flexing and rippling of the cone from its apex to its periphery. Under these circumstances, the acoustical characteristics of the cone material itself, which determine the cone's “self-noise,” or “acoustic signature” contribute significantly to the sound reproduction coloration. By way of illustration of self-noise, a thin sheet of aluminum waved rapidly in the air causes rippling and flexing in the sheet, which results in the emission of an audible rattling or “thunder” noise. This is the self-noise of the sheet. Even paper cones emit a “cone cry” when flexed and rippled. In contrast, a silk scarf waved rapidly in the air produces virtually no self-noise.

The physical properties and structural arrangement of the material from which a speaker cone is made can significantly affect the self-noise of the speaker. To avoid the flexing motion that excites self-noise in woofers, most traditional two and three-way loudspeaker systems incorporate an electrical “crossover” network that includes a low pass filter, which allows only frequencies with longer wavelengths to pass to the woofer. Higher frequencies are directed by the crossover to smaller mid-range speakers and/or tweeters of the system, which reproduce the midrange and high frequency content of the audio program.

Similar considerations apply to tweeters and other higher frequency transducers used in modern loudspeaker systems. Many such transducers utilize small (typically about 1 inch in diameter) domes made of silk, polycarbonate (also known as PC or Lexan®), polyethylene terephthalate, (also known as PET or Mylar®), or metals (such as aluminum or titanium). If the dome of an aluminum or polycarbonate dome tweeter is flexed by, for example, being poked with a finger, the dome's self-noise can be audibly observed. The dome will emit a crackling noise. Such domes may therefore be said to have a relatively high self-noise. In contrast, if the diaphragm of a silk dome tweeter is poked with a finger, it will flex relatively silently. Silk dome tweeters may be said to have low self-noise.

The self-noise of a tweeter also can be activated by the vibratational flexing induced in the dome during the reproduction of an audio program. However, since the self-noise typically is only audible for a small portion of the tweeter's upper frequency response range, it generally is a secondary consideration when designing traditional loudspeaker systems. Generally speaking, higher quality loudspeaker systems are designed to minimize the self-noise of its various transducers in order to reproduce the original audio program material as accurately and clearly as possible without introducing unrelated modulations, spurious resonances, and other sounds characteristic of self-noise (i.e. they are designed to exhibit high signal-to-noise ratios).

It will be obvious from the forgoing discussion that the physical and material properties of the materials from which speaker cones and domes are fabricated determine, to a large degree, the self-noise of the speaker. Generally speaking, such characteristics include the stiffness of the material, its tensile strength, thickness, density, the material's Young's Modulus (E), as well as its internal damping characteristics, among other factors. Another key parameter for diaphragm materials is the speed of sound in that material. In homogenous materials, the speed of sound equals the square root of the ratio of Young's modulus to the density. The damping may be measured by a “loss factor” (or μ), or the “tan delta,” both of which measure a material or structure's ability to dissipate energy and thus to damp vibrations that otherwise would be radiated from the structure as unwanted sound, or noise. Determining the optimum materials from which to fabricate the cones and domes of speakers to provide the efficient reproduction and the highest signal-to-noise ratio for a given frequency band, sensitivity, and acoustic output level has long been the quest of loudspeaker designers.

In recent years, “flat diaphragm” or “flat panel” sound radiators have gained popularity as alternatives to traditional loudspeakers. The term “flat” is used herein in a relative sense and refers to the fact that the diaphragm is no longer the typical cone speaker, which roughly is about as deep as its diameter. Flat panel sound radiators discussed herein retain a thickness on the order of a few millimeters for a radiating area on the order of one half square meter or less. In alternative embodiments, this may be scaled up to a larger thickness for radiating areas, for example, of one half-meter square or greater. Alternatively, these flat panel sound radiators may employ multiple thinner diaphragms, in alternative embodiments, or be scaled downward for smaller radiators, perhaps of the order of one tenth of a square meter or less. Flat here excludes loudspeakers utilizing polymer film diaphragms, using electrodynamic or electrostatic generation of motive force, as well as those loudspeakers that use the diaphragm itself as the voice coil (“ribbons”) or those speakers using piezo-electric generation of mechanical force.

Flat panel sound radiators generally include a flat resonant panel that is excited or driven by an electro-mechanical transducer or exciter to vibrate the panel to produce sound. The exciter often is mounted directly to the back side of the panel and, when provided with audio frequency vibrational signals from an audio amplifier, transmits the resulting mechanical vibrations to the panel, which vibrates to couple the sounds to ambience. Flat panel sound radiators have many beneficial uses such as, for example, installation in the grid of a suspended ceiling system in place of a traditional ceiling panel as a component of a sound distribution system in a building.

Much research has been devoted to the development of flat panel sound radiators by companies such as New Transducers Limited of Great Britain, also known as NXT, and Dai-Ichi of the Philippines. Numerous patents directed to various aspects of flat panel sound radiator technology have been issued to NXT, SLAB, BES, Sound Advance, and others, and the disclosures of such patents are hereby incorporated by reference as if fully set forth herein.

In many cases, the panel of a prior art flat panel sound radiator is formed from a core of honeycomb, foam (such as polystyrene foam, or mixtures of polystyrene foam with, for example, Neoprene), or other material sandwiched between front and back facing skins. A low density core material sandwiched between high density skins such as metal skins on a foam core—can be very stiff for a given total diaphragm weight. Relatively high stiffness for a given weight (the specific stiffness) means that for a given stiffness, the diaphragm may be lighter. Lighter diaphragms are more efficient at converting electrical input to acoustical output, often considered a significant performance advantage. Composite structures such as these may be very stiff—so stiff that when their motion becomes non-pistonic, the break-up and self noise of the panel may be unusually severe. This break up is uncontrolled and unpredictable, leading to very irregular frequency and time response, high harmonic and non-harmonic distortion, low signal to noise characteristics, and a harsh subjective sound. The break-up problem may be exacerbated by a stiff surround, the supporting compliant structure.

Unlike traditional cone and dome speakers, which produce sound largely through pistonic motion of speaker cones, a certain class of flat panel sound radiators reproduces sound by a mechanism known as “distributed mode” reproduction. Flat panel sound radiators are thus sometimes known as distributed mode sound radiators. Generally in such sound radiators, an exciter, which typically is of the traditional electro-dynamic voice-coil and magnet type, but may also be a piezo ceramic element, is operatively coupled to a flat panel radiator at a specific location. When provided with audio frequency signals from an amplifier, the exciter imparts localized vibrational bending to the panel at acoustic frequencies. These bending mode vibrations propagate or are distributed through the panel from the location of the exciter towards and perhaps to the edges of the panel. Bending waves propagate through the panel, typically with the wave speed varying with frequency. The shape of the expanding wave front that moves away from the location of the exciter is not necessarily preserved as a smoothly expanding series of circularly concentric waves, as they would in an idealized conventional cone speaker. Various bending modes are excited within the structure of the panel, which in part depend on the boundary conditions at the edge of the panel as well as the physical shape (square panels vibrate differently than rectangular, elliptical, etc). In addition, the shape of a panel can be manipulated to emphasize the interleaving of appropriate bending modes. In any event, the spread of resonant modes of vibration throughout most of area of the panel couples acoustically to the surrounding air to reproduce the sounds of an audio program in a fundamentally non-pistonic manner.

The distributed mode reproduction of sound that is characteristic of flat panel sound radiators offers what are considered by some to be distinct advantages over sound reproduced through the pistonic motion of traditional loudspeakers. For example, since the sound radiation into the surrounding space is effectively from the entire panel surface, the resulting sound field tends to be highly diffuse and non-directional over a wide range of audio frequencies. Furthermore, the intrinsic proximity and directional dispersion variations that are characteristic of traditional pistonic loudspeakers (and that are largely responsible for the existence of only a few good listening positions or “sweet spots” within a room) are essentially eliminated with flat panel distributed mode sound radiators. Finally, the tendency with traditional loudspeakers for bass frequencies to reinforce or cancel due to room resonance and thus to seem louder or softer depending upon one's location in a room is minimized when using flat panel sound radiators. The ultimate result is a high quality diffuse sound field that, in large measure, maintains its stereo image, frequency content, and relative volume characteristics at virtually any location within a room. These acoustical advantages in conjunction with the small thickness and aesthetically pleasing appearance of flat panel sound radiators (they can be made to be indistinguishable from a traditional ceiling tile in a suspended ceiling, for example) make them desirable for a wide variety of applications.

While the pace of development of flat panel distributed mode sound radiators has been brisk, several fundamental problems and shortcomings of existing flat panel sound radiators persist. Many of these shortcomings relate to the physical characteristics and acoustic properties of the materials from which the panels of flat panel sound radiators have been made. The common wisdom, as is taught in many of the NXT patents mentioned above, has been that the panel should be fabricated to have a high stiffness in order to enhance the distribution of sound waves throughout the panel. To achieve this goal, flat panel sound radiator designers have heretofore used rigid or stiff materials for the cores and opposed facing skins of the panel between which the core is sandwiched. Further, rigid adhesives have been used to attach the skins to the core. For example, some flat panel sound radiators have been made with lightweight panels designed for the aircraft industry. Such panels typically have aluminum facing skins and aluminum honeycomb cores held together with rigid resins and epoxies to enhance stiffness. In other cases, honeycomb core panels designed for the carton industry and having paper or plastic facing skins sandwiching foam or paper cores have been used.

While such panels are functional and do indeed reproduce sound, they have nevertheless not generally produced high quality sound with good low frequency content nor have they been able to reproduce sound at higher volume levels. Among the causes of poor bass response is the fact that the high panel stiffness of prior art flat panel sound radiators results in a high mechanical impedance at lower audio frequencies. This means that the panel increasingly resists and suppresses movement of the exciter within the lower frequency ranges of the audio content. Good bass response requires relatively large panel excursions. Prior art panels, however, resist being moved by the exciter at lower frequencies, thus resulting in a characteristic bass response roll-off in such panels. In applications where sound quality is important, this bass frequency roll-off sometimes has been addressed by providing a traditional pistonic woofer in conjunction with a flat panel sound radiator. The woofer reproduces audio below a crossover frequency of about 400 Hz and the flat panel sound radiator reproduces only audio content above the crossover frequency. Unfortunately, this solution is not feasible in many applications where flat panel sound radiators are most desirable. Further, the introduction of a pistonic woofer reintroduces many of the shortcomings of such pistonic speakers discussed above. The same inherent resistance to larger excursions characteristic of prior art stiff panels also limits severely the volume or loudness of an audio program than can be reproduced. Thus, prior art flat panel sound radiators have generally been applicable to lower volume and lower sound quality applications.

Another contributing factor to poor bass response and low volume limits in some prior art flat panel sound radiators (e.g., panels made entirely of foam without structural skins) is the low tensile strength of the materials used to construct the panels. Such materials tend to tear and generally break down when exposed to the higher excursions of bass frequencies and high sound pressure levels, thus contributing to the inherent limitations of these characteristics.

In addition to poor bass response and low volume limits, prior art flat panel sound radiators also have been plagued with low signal-to-noise characteristics compared to traditional pistonic loudspeakers. In other words, the difference in decibels between the self-noise of the speaker and the reproduced audio program is low, resulting in a coloration or contamination of the sound quality. As discussed above, heretofore commonly used sheet materials made of aluminum, plastic, and even cardboard, while perhaps exhibiting a high Young's Modulus, nevertheless have high self-noise, as can be demonstrated by flapping a representative sheet rapidly in the air. This self-noise can be minimized in traditional loudspeakers by frequency distribution among woofers and tweeters in such a way that each driver operates essentially in a pistonic mode, and generally designing the product to prevent resonant modes, be they in the diaphragm itself or components of the suspension, such as the surround. However, in prior art flat panel sound radiators, virtually all sound throughout the entire frequency range is reproduced in a distributed mode by the propagation of bending waves through the body of the panel. Acoustic output through the entire frequency range is generated by bending and flexing of the panel rather than pistonic motion. Bending and flexing causes self-noise. It can thus be seen that the high self-noise of the materials from which prior art flat panels often are constructed is significant when compared to the reproduced audio signal. In other words, the signal-to-noise for such systems is typically low, perhaps around 25 dB. This compares to signal-to-noise ratios of 40 dB and higher in good traditional loudspeaker systems. The ultimate result is low quality, noisy, and aurally irritating sound reproduction.

Accordingly, a need exists for an improved flat panel sound radiator that successfully addresses the problems and shortcomings of prior art flat panel sound radiators. Such a sound radiator should produce the low frequency range of audio program material efficiently and with clarity (as defined by a good performance in spectral contamination tests) and should be capable of producing sound at significantly higher sound pressure levels than prior art, including higher sound level in the lower frequencies (i.e. good base response). The sound radiator should exhibit low self-noise akin to that of good traditional loudspeaker systems, whilst exhibiting the size and aesthetic advantages of flat panel sound radiators. It is to the provision of such a flat panel sound radiator that the present invention is primarily directed.

### SUMMARY OF THE INVENTION

Briefly described, the present invention comprises an improved panel for use in a flat panel sound radiator that addresses and overcomes the problems and shortcomings of the prior art. In a preferred embodiment, the panel is constructed with a honeycomb core sandwiched between front and back facing skins that are secured to the core with adhesive. The materials from which the core, skins, and adhesive are made are carefully selected to optimize the stiffness, strength, flexural properties (such as static and dynamic bending stiffness), and acoustic characteristics to meet the criteria of low self-noise, good bass frequency response, high sound pressure level capability, good acoustical damping, and a high signal-to-noise comparable to that of conventional flat and conical diaphragm loudspeaker systems.

In one preferred embodiment, the honeycomb core of the panel is fabricated from Kraft paper rather than aluminum as in some prior art panels. The Kraft paper core is phenolic impregnated for stiffness and dimensional stability, particularly in regards to increased resistance to moisture absorption. The Kraft paper provides both high flexibility and exhibits exceptionally low self-noise.

The front and back facing skins of the panel of the preferred embodiment are fabricated from an aramid polyamide such as Kevlar or Dupont Nomex, which exhibits, simultaneously, a high Young's modulus for rapid dispersion of sound waves through the panel, exceptional energy dissipation characteristics for superior damping of large vibrational excursions, and very low self-noise (the latter two properties are indicated by the skin—as well as the core—having a high “loss factor” as discussed herein). In addition, these materials exhibit superb tensile strength to withstand bending and flexing during sound reproduction, particularly at higher volumes, without cracking, notching, or creasing. The aramid polyamide skins are secured to the core with a flexible adhesive with good damping characteristics such as, for example, water based acrylic, rubber cement, or a silicone adhesive.

A flat panel sound radiator fabricated according to the present invention has been shown to exhibit significantly extended bass response when compared to prior art flat panel sound radiators. In addition, due to its low self-noise, the signal-to-noise of the sound radiator has been measured to be above about 40 dB for an 85 dB input signal, which is comparable to that of good traditional loudspeaker systems. Audio program material can be reproduced at substantially higher volume levels than with prior art flat panel sound radiators and the material of the panel withstands even the most punishing audio reproduction without cracking, creasing, or otherwise degrading. Thus, the essence of the present invention is a flat panel sound radiator having a panel fabricated from materials with physical and acoustical characteristics that result in extended bass reproduction, enhanced volume capability, high signal-to-noise ratio, and enhanced ruggedness. These and other features, objects, and advantages of the invention will become more apparent upon review of the detailed description set forth below when taken in conjunction with the accompanying drawing figures, which are briefly described as follows.

### BRIEF DESCRIPTION OF THE DRAWINGS

FIG. 1 is a perspective view of a flat panel sound radiator that embodies principles of the invention in a preferred form.

FIG. 2 is an enlarged partially cut-away perspective view of the panel of the sound radiator of FIG. 1 illustrating the honeycomb core and facing skins secured together with adhesive.

FIG. 3 is a graph of dB level versus frequency showing the results of a spectral contamination test performed on a flat panel sound radiator of the present invention and illustrating its superior signal-to-noise characteristics.

FIG. 4 is a graph of dB versus frequency showing the results of a frequency response test performed on a flat panel sound radiator of the present invention and illustrating its improved response.

### DETAILED DESCRIPTION OF THE PREFERRED EMBODIMENTS

Referring now in more detail to the drawings, FIG. 1 illustrates a flat panel sound radiator that embodies principles of the present invention in one preferred form. It will be understood that the sound radiator may take on any of a number of sizes and shapes according to the intended end use of the panel. Furthermore, the panel of the sound radiator may be and often is mounted within a support frame or other structure as required by the application. For example, in flat panel sound radiators for installation within an opening of a suspended ceiling grid, the panel may be mounted within a square or rectangular metal frame, which supports the edges of the sound radiator panel and provides a support for a sound transmitting grill that covers the panel and that may be made to look like the exposed surfaces of surrounding ceiling panels within the grid.

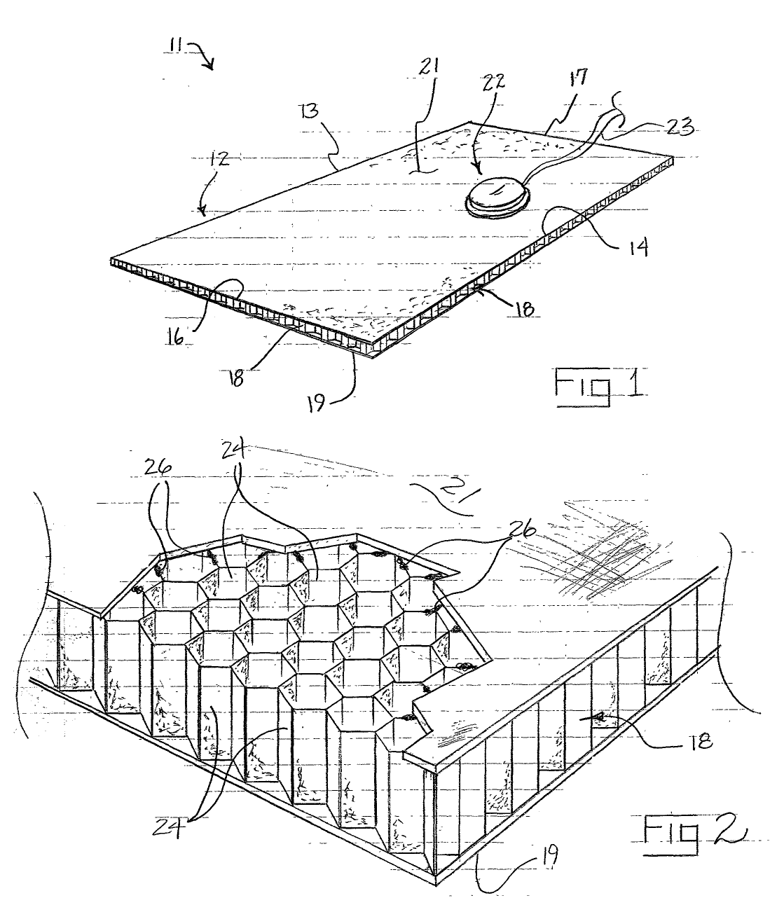

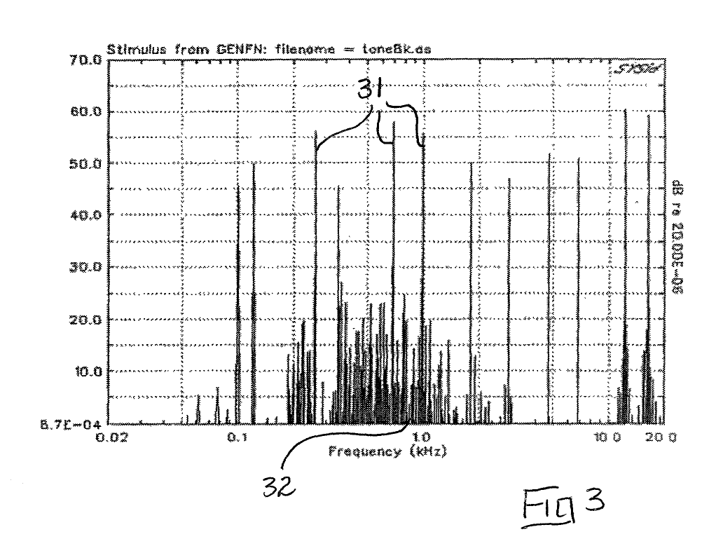

The flat panel sound radiator 11 generally comprises a panel 12 having side edges 13 and 14 and end edges 16 and 17. The panel 12 is formed with a core 18 that is sandwiched between a front facing sheet 19 and a rear-facing sheet 21. The core may take on a variety of physical configurations but, as described in more detail below, preferably is configured with a hexagonal open cell structure commonly referred to as a “honeycomb” structure. The front and back facing sheets 19 and 21 each is secured to the honeycomb core 18 with adhesive 26 (FIG. 2).

An electromechanical driver or exciter 22 is mounted to the back side 21 of the panel 12 and is electrically coupled by wires 23 to an audio power amplifier (not shown) for driving the exciter with alternating current corresponding to an audio program to be reproduced by the sound radiator. The exciter 22 may take on any of a variety of configurations for imparting vibrational bending to the panel 12. Some exciter configurations are disclosed in the above referenced patents of NXT, and others are possible. Further, although the exciter 22 is illustrated in FIG. 1 as being attached directly to and supported by the panel 12, drivers supported by bridges or other support structures also are possible and should be considered to be within the scope of the present invention.

FIG. 2 is an enlarged partially sectioned view of a portion of the panel 12. The panel is seen to be constructed with a core 18 that is formed, in the illustrated embodiment, with a honeycomb configuration. Specifically, the core 18 is formed to exhibit a plurality of interconnected hexagonal cells 24 that together resemble the cells of a bee's honeycomb. Such a core structure has been used in composite panels in, for example, the aircraft industry for some time because of its structural integrity when sandwiched between facing sheets and its light weight. However, in the aircraft industry at least, such cores generally are formed of aluminum. For use in a sound radiator panel, an aluminum core is not desirable because, as discussed above, aluminum has a high inherent self-noise when flexed, which contributes to a low signal-to-noise in a sound radiator panel. Instead, the core 18 of the present invention is formed of a material that has inherently low self-noise, is somewhat flexible, and has good acoustic damping properties. In this regard, it has been found that a honeycomb core made of Kraft paper exhibits these properties and enhances the sound reproduced by the sound radiator panel. Other materials also might be chosen so long as they exhibit the desirable material properties discussed above.

Generally, the walls of the honeycomb core material should be as thin as possible to provide sufficient support while reducing the overall mass of the panel and to transfer vibrations efficiently between the front and back facing sheets of the panel. The overall thickness of the core is kept as thin as possible to provide the required mechanical support for the panel (i.e. to prevent drooping) while minimizing the panel stiffness. Finally, the honeycomb cell size also is a consideration in balancing stiffness with flexibility. In the preferred embodiment, the Kraft paper core has cells with a wall thickness of 0.07 mm with the overall height or thickness of the core itself being about 7 mm. The cell core diameter (defined as the distance between the planes defined by parallel cell walls of the individual hexagonal cells) preferably is about 4 mm.

The Kraft paper core 18 is sandwiched between a front facing sheet 19 and a back facing sheet 21. The facing sheets 19 and 21 are made of a material that, like the core, has a high Young's modulus, a high tan delta, and low self-noise. It is unusual for a material to exhibit both a high Young's modulus and a high tan delta simultaneously. For example, typical skins of lightweight honeycomb panels are made of aluminum or titanium, which have a high Young's modulus but a very low tan delta. In addition, such materials are inherently noisy when flexed. However, the inventors have found that various species of aramid polyamides such as, for example, Dupont's Nomex, Kevlar, and Teijin's Conex and Technora from Teijin exhibit both a high Young's modulus, a high tan delta or loss factor, and have inherently low self-noise. An additional benefit is that such materials have inherently high tensile strength so that they easily survive large excursions during high volume sound reproduction without tearing, cracking, or creasing.

In the preferred embodiment, the front and back skins are made of a meta-aramid such as Kevlar with a thickness of about 0.127 mm. Kevlar has a Young's modulus of about 1×10¹⁰ N/m, a tan delta of about 0.05, and a tensile strength of about 137 N/cm in the machine direction and about 66 N/cm in the cross direction. Kevlar also exhibits a very low self-noise when flexed during acoustic vibration. Generally speaking, the thickness of the front and back facing sheets should be less than about 0.2 mm.

The front and back facing sheets 19 and 21 are secured to the honeycomb core with adhesive 26. The adhesive is chosen for its flexibility, high acoustic damping characteristics, and high shock resistance (no cracking or crazing under prolonged vibrational operation). Example adhesives that meet these criteria include water-based acrylic adhesives, rubber cements and silicone adhesives, but other types of adhesives might suffice as well.

With the unique combination of components as described above, flat panel sound radiators have been constructed that, when stimulated with a series of discreet sound tones, exhibit a signal-to-noise of greater than 40 dB for 85 dB input signals. This compares well with high quality traditional loudspeakers. In addition, the refuced stiffness of the panel of this invention results in enhanced frequency response, particularly at low frequencies. Finally, the toughness and high tensile strength of the polyamide skin and the flexibility of the adhesive resists structural damage under high excursion conditions. Thus, the sound radiator is able to produce significantly increased sound pressure levels compared to prior art flat panel sound radiators.

### EXAMPLE

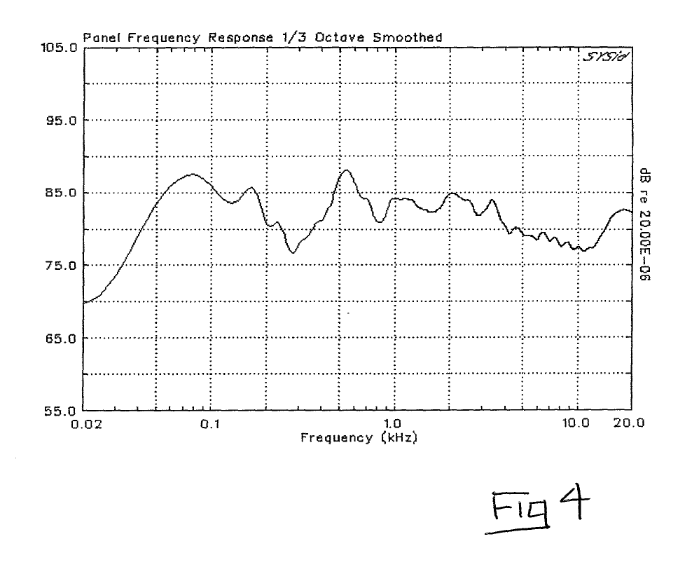

A flat panel sound radiator was constructed according to the invention with the material properties listed below and subjected to spectral contamination and frequency response tests. The results of the tests are illustrated in FIGS. 3 and 4. The panel itself, which was approximately one-half meter by one-half meter in overall size, was fabricated as follows.

CORE: The honeycomb core of the test panel was constructed from Kraft paper with an overall thickness (measured perpendicular to the plane of the panel) of 7 mm, a cell diameter of 4 mm, and a cell wall thickness of about 0.07 mm.

SKINS: The facing skins of the test panel were constructed from Nomex® with a thickness of 5 mils (0.13 mm). The Nomex® had a tensile strength of 137 N/cm, a density of 0.87 g/cc, a Young's modulus of 2×10¹⁰ dyn/cm squared, and a tan delta (a dimensionless parameter) of approximately 0.050. Further, Nomex® is a flexible cloth-like material with inherently low self-noise and high tensile strength, as well as fire resistance.

ADHESIVE: The Nomex facing skins were secured to the Kraft paper core with a flexible water based acrylic adhesive.

EXCITER: The exciter for imparting acoustic vibrations to the panel was an electro-mechanical driver of the type typically used in prior art flat panel sound radiator systems.

Spectral Contamination Test: The flat panel sound radiator was subjected to a standard spectral contamination test as follows. The sound radiator was connected to an audio amplifier and stimulated with sine wave test tones at 12 discrete frequencies selected so that their distortion products minimally overlap each other. The audio response of the sound radiator was then measured with a SYSid Acoustic Analysis System, a high resolution FFT analyzer with s/n ratio of over 120 dB, at a plurality of frequencies from 20 Hz to 20 kHz and generally in between the frequencies of the discrete test tones. The result of the test is presented in the spectral contamination chart of FIG. 3. As can be seen, the test sound radiator exhibited high signal-to-noise of greater than 40 dB for an 85 dB input signal and, at many frequencies, greater than 50 dB. Of particular note is the unusually low level of distortion products (the signal levels between the 12 test tone frequencies), in the critical listening region between approximately 1 kHz and approximately 10 kHz. The signal-to-noise performance of the test panel, which incorporates the present invention, generally is more than 20 dB better than traditional prior art flat panel sound radiators.

Frequency Response Test: The test panel was subjected to a standard ⅓ octave frequency response test wherein the audio response in dB of the panel to a constant input signal across the frequency domain was measured by a microphone at a plurality of audio frequencies between 20 Hz and 10 kHz. The results of the test are presented in FIG. 4. It can be seen from this test result that the panel responded well, particularly in the 1 kHz to 10 kHz range. Furthermore, the bass response of the panel was far superior to that which would be expected from a traditional prior art flat panel sound radiator, only beginning to roll off at about 70 Hz.

It is clear from the test results presented above and illustrated in FIGS. 3 and 4 that a flat panel sound radiator fabricated from the combination of materials according to the invention exhibits substantially enhanced audio performance. More specifically, the sound radiator produces clearer and cleaner sound with substantially reduced self noise because of its high signal-to-noise characteristics and also has an extended frequency response that results in clearer and fuller bass reproduction.

The invention has been described herein in terms of preferred and somewhat specific embodiments and methodologies. Variations of the preferred embodiments presented herein are possible and should be considered to be within the scope of the invention. For instance the cell wall thickness of the honeycomb core in the preferred embodiment was 0.07 mm. In fact, the cell wall thickness may be any value less that about 0.5 mm depending upon a variety of application specific constraints. Likewise, the overall core thickness (7 mm in the preferred embodiment) may be any value less than about 70 mm depending upon the structural requirements of the panel. The thickness of the facing skins also may vary from the 0.127 mm thick Kevlar skin of the preferred embodiment within a range less than about 0.5 mm. Finally, depending upon the material, measured characteristics of the skin, such as its tensile strength, Young's modulus, tan delta, and self noise may vary from the specific characteristics of the preferred embodiment. In general, however, the tan delta and Young's modulus of the material as well as its tensile strength should each be at least as high as those of the preferred embodiment such that the skin material simultaneously exhibits rapid dispersion of energy and thus rapid damping of sound waves, and low self noise that results in a high signal-to-noise characteristic for the panel. Various other additions, deletions, and modifications may be made to the illustrated embodiments without departing from the spirit and scope of the invention as set forth in the claims.

What is claimed is:

1. A flat panel sound radiator with enhanced audio performance, said flat panel sound radiator comprising:
a panel having a core of a first material sandwiched between facing skins of a second material, said facing skins being secured to said core with an adhesive;
an exciter coupled to said panel for imparting vibrations corresponding to audio program material to said panel;
said second material having a Young's modulus and a tan delta each sufficiently high such that said flat panel sound radiator, when subjected to a spectral contamination test, exhibits a signal-to-noise greater than 40 dB for an input signal of 85 dB within a frequency range from about 1 kHz to about 10 kHz.

2. A flat panel sound radiator as claimed in claim 1 and wherein said second material has a Young's modulus greater than about 1×10¹⁰ N/m and a tan delta greater than about 0.05.

3. A flat panel sound radiator as claimed in claim 1 and wherein said second material has a tensile strength greater than about 66 N/cm.

4. A flat panel sound radiator as claimed in claim 1 and wherein said facings skins have a thickness less than about 0.5 mm.

5. A flat panel sound radiator as claimed in claim 4 and wherein said facing skins have a thickness of about 0.127 mm.

6. A flat panel sound radiator as claimed in claim 1 and wherein said second material is an aramid polyamide.

7. A flat panel sound radiator as claimed in claim 6 and wherein said second material is Nomex®.

8. A flat panel sound radiator as claimed in claim 6 and wherein said second material is Kevlar®.

9. A flat panel sound radiator as claimed in claim 6 and wherein said second material is Conex®.

10. A flat panel sound radiator as claimed in claim 6 and wherein said second material is Technora®.

11. A flat panel sound radiator as claimed in claim 1 and wherein said core has a honeycomb structure.

12. A flat panel sound radiator as claimed in claim 11 and wherein said core is formed of Kraft paper.

13. A flat panel sound radiator as claimed in claim 12 and wherein said honeycomb core has a thickness less than about 70 mm.

14. A flat panel sound radiator as claimed in claim 13 and wherein said honeycomb core has a thickness of about 7 mm.

15. A flat panel sound radiator as claimed in claim 14 and wherein said honeycomb core has a cell diameter of about 4 mm.

16. A flat panel sound radiator as claimed in claim 15 and wherein said honeycomb core has a cell wall thickness less than about 0.5 mm.

17. A flat panel sound radiator as claimed in claim 16 and wherein said honeycomb core has a cell wall thickness of about 0.07 mm.

18. A flat panel sound radiator as claimed in claim 1 and wherein said adhesive is chosen for its relatively high flexibility, relatively high acoustic damping characteristics, and relatively high shock resistance.

19. A flat panel sound radiator as claimed in claim 18 and wherein said adhesive is a silicone adhesive.

20. A flat panel sound radiator as claimed in claim 18 and wherein said adhesive is a water-based acrylic adhesive.

21. A flat panel sound radiator as claimed in claim 18 and wherein said adhesive is a rubber cement.

22. A panel for use in a flat panel sound radiator, said panel comprising:
a honeycomb core and having a thickness, a cell diameter, and a cell wall thickness, said honeycomb core being made of a first material having first material properties and first acoustic properties;
said honeycomb core being sandwiched between facing skins and being secured to said facing skins with adhesive;
said facing skins being made of a second material having second material properties and second acoustic properties;
said first material and first acoustic properties of said first material and said second material and second acoustic properties of said second material being pre-selected such that said panel, when subjected to an acoustic spectral contamination test, exhibits a signal-to-noise greater than 40 dB for an input signal of 85 dB within a predetermined audio range.

23. A panel as claimed in claim 22 and wherein said first material comprises Kraft paper.

24. A panel as claimed in claim 23 and wherein said second material comprises an aramid polyamide.

25. A panel as claimed in claim 24 and wherein said adhesive is a water-based acrylic adhesive.

26. A panel as claimed in claim 24 and wherein said adhesive is chosen from the group consisting of silicone adhesive and rubber cement.

27. A flat panel sound radiator comprising a panel and an exciter coupled to said panel for imparting acoustic vibrations to said panel for reproduction, said panel having a core made of a first material sandwiched between facing skins made of a second material, said first and second materials having material and acoustic properties pre-selected such that said flat panel sound radiator exhibits a signal-to-noise greater than 40 dB for an input signal of about 85 dB within a frequency range between about 1 kHz and about 10 kHz when subjected to a spectral contamination test.

28. A flat panel sound radiator as claimed in claim 27 and wherein said second material is an aramid polyamide.

29. A flat panel sound radiator as claimed in claim 28 and wherein said first material is Kraft paper.

30. A flat panel sound radiator as claimed in claim 29 and wherein said core is a honeycomb core.

31. A flat panel sound radiator as claimed in claim 27 and wherein said facing skins are secured to said core with an adhesive.

32. A flat panel sound radiator as claimed in claim 31 and wherein said adhesive is a water-based acrylic adhesive.

33. A flat panel sound radiator as claimed in claim 31 and wherein said adhesive is a silicone adhesive.

34. A flat panel sound radiator as claimed in claim 31 and wherein said adhesive is rubber cement.
